(19) United States
(12) Patent Application Publication
(10) Pub. No.: US 2023/0003986 A1
(43) Pub. Date: Jan. 5, 2023

(54) SURGICAL MICROSCOPE SYSTEM AND MICROSCOPE CAMERA ADAPTER

(71) Applicant: SONY GROUP CORPORATION, TOKYO (JP)

(72) Inventors: TOMOYUKI OKI, TOKYO (JP); HIDEKI NAKAJO, TOKYO (JP); HIDEO NAKAMURA, TOKYO (JP); HITOSHI FUKUHORI, TOKYO (JP)

(21) Appl. No.: 17/756,229

(22) PCT Filed: Nov. 13, 2020
(86) PCT No.: PCT/JP2020/042375

§ 371 Date: May 19, 2022

(30) Foreign Application Priority Data
Nov. 28, 2019 (JP) 2019-215560

(51) Int. Cl. G02B 21/00; G02B 21/22; G03B 13/32; G02B 7/06

(52) U.S. Cl. CPC G02B 21/0012; G02B 21/22; G03B 13/32; G02B 7/06

(57) ABSTRACT

The present disclosure relates to a surgical microscope system and a microscope camera adapter that enable various types of adjustment in a camera adapter connecting the cameras that capture a three-dimensional image, with right and left cameras simultaneously. Of respective right and left lens groups that constitute respective focus lenses, right and left lenses between lenses closest to a side of an objective lens and lenses closest to sides of eye lenses are simultaneously moved by the same distance according to a setting value, by which focus is adjusted. The present invention can be applied to a surgical microscope system.

### TECHNICAL FIELD

The present disclosure relates to a surgical microscope system and a microscope camera adapter, and more particularly to a surgical microscope system and microscope camera adapter capable of simultaneously adjusting right and left images in observation of a three-dimensional image.

### BACKGROUND ART

In order to display/record an image observed by a microscope used for surgery (hereinafter, also simply referred to as a surgical microscope), a camera adapter for attaching an external camera is becoming widespread.

In recent years, with increasing demand for three-dimensional images observed by a surgical microscope, there has been proposed a camera adapter that optically connects two cameras and a surgical microscope in order to display/record both a right-eye image and a left-eye image.

With a camera adapter, in order to enhance sense as a three-dimensional image, it is important to eliminate difference between a right-eye image and a left-eye image so that a sense of depth (disparity) can be adjusted.

Therefore, a technique has been proposed in which a focus adjustment function is provided to each of a camera that captures a right-eye image and a camera that captures a left-eye image so that focus of each of the right-eye image and left-eye image can be adjusted (refer to Patent Document 1).

Furthermore, a technique in which an intermediate lens barrel is provided with a mechanism capable of adjusting a distance between optical axes (refer to Patent Document 2), or the like has been proposed.

### CITATION LIST

### Patent Document

Patent Document 1: Japanese Patent Application Laid-Open No. 2014-145968
Patent Document 2: Japanese Patent Application Laid-Open No. 2010-160342

### SUMMARY OF THE INVENTION

### Problems to be Solved by the Invention

However, because the focus adjustment is to adjust each of the camera that captures a right-eye image and the camera that captures a left-eye image individually, it is necessary to adjust the cameras for right eye and left eye individually in a case where adjustment is required during surgery, which is troublesome and may increase surgery time.

The present disclosure has been made in view of such a problem, and an object of the present disclosure is to facilitate adjustment of a right-eye image and a left-eye image in observation of an operative field with a three-dimensional image.

### Solutions to Problems

A surgical microscope system according to a first aspect of the present disclosure is a surgical microscope system including an optical adjustment unit that is provided between an objective lens and eye lenses in a surgical microscope, and adjusts an optical system so that two imaging devices are able to capture images of an operative field as a right-eye image and a left-eye image, a control unit that performs control so that adjustment, by the two imaging devices, of an optical system used for capturing the right-eye image and the left-eye image is simultaneously performed in the optical adjustment unit, an imaging control unit that controls each of the imaging devices and outputs an image signal generated by the imaging devices, and a display unit that displays an image based on the image signal output from the imaging control unit.

In the first aspect of the present disclosure, an optical adjustment unit is provided between an objective lens and eye lenses in a surgical microscope, an optical system is adjusted so that two imaging devices are able to capture images of an operative field as a right-eye image and a left-eye image, control is performed so as to simultaneously adjust an optical system used for capturing the right-eye image and the left-eye image by the two imaging devices, the imaging device is controlled to output an image signal generated by the imaging device, and an image based on the output image signal is displayed.

A microscope camera adapter according to a second aspect of the present disclosure is a microscope camera adapter including an optical adjustment unit that is provided between an objective lens and eye lenses in a surgical microscope, and adjusts an optical system so that two imaging devices are able to capture images of an operative field as a right-eye image and a left-eye image, and an adjustment unit that simultaneously adjusts, in the optical adjustment unit, an optical system used for capturing the right-eye image and the left-eye image by the two imaging devices.

In the second aspect of the present disclosure, an optical adjustment unit is provided between an objective lens and eye lens in a surgical microscope, an optical system is adjusted so that two imaging devices are able to capture images of an operative field as a right-eye image and a left-eye image, and an optical system used for capturing the right-eye image and the left-eye image by the two imaging devices is adjusted simultaneously.

### BRIEF DESCRIPTION OF DRAWINGS

FIG. 1 is a diagram describing a configuration example of a microscope system according to the present disclosure.

FIG. 2 is a diagram describing a configuration example of a camera adapter.

FIG. 3 is a diagram describing a configuration example of an adapter controller.

FIG. 4 is a diagram describing a configuration adjusted by the adapter controller.

FIG. 5 is a diagram describing base length adjustment.

FIG. 6 is a diagram describing aperture adjustment.

FIG. 7 is a diagram describing focus adjustment.

FIG. 8 is a diagram describing disparity adjustment.

FIG. 9 is a diagram describing another example of disparity adjustment.

FIG. 10 is a diagram describing a modification of the camera adapter.

### MODE FOR CARRYING OUT THE INVENTION

Hereinafter, a preferred embodiment of the present disclosure will be described in detail with reference to the appended drawings. Note that, in this specification and the drawings, components having substantially the same functional configuration are provided with the same reference signs, so that repeated description of these components is omitted.

Hereinafter, an embodiment for carrying out the present technology will be described. The description will be made in the following order.

1. Preferred embodiment

2. Modifications

### 1. Preferred Embodiment

<Microscope System>

The present disclosure enables adjustment of each of a right-eye image and left-eye image in observation of a three-dimensional image to be easily achieved by one operation.

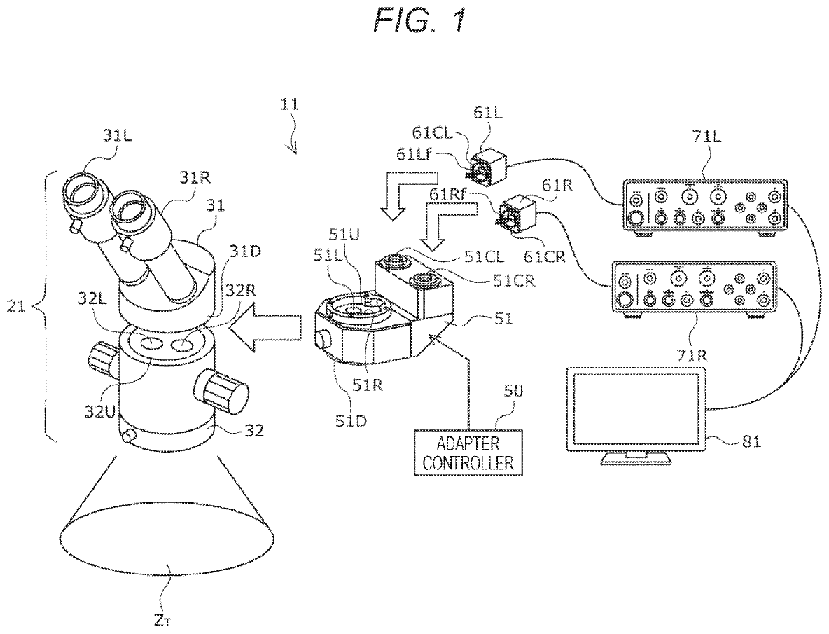

FIG. 1 is a diagram describing a configuration example of a microscope system according to the present disclosure.

A microscope system 11 includes a microscope 21, an adapter controller 50, a camera adapter 51, camera control units (CCUs) 71L, 71R, and a monitor 81.

The microscope 21 is, for example, a surgical microscope that allows a surgeon to visually recognize an affected area by enlarging an operative field Zr by looking into eyepieces 31L, 31R. Note that, although description will be given on assumption that the microscope 21 is a surgical microscope in this specification, the technology according to the present disclosure can also be applied to a microscope for other than surgery.

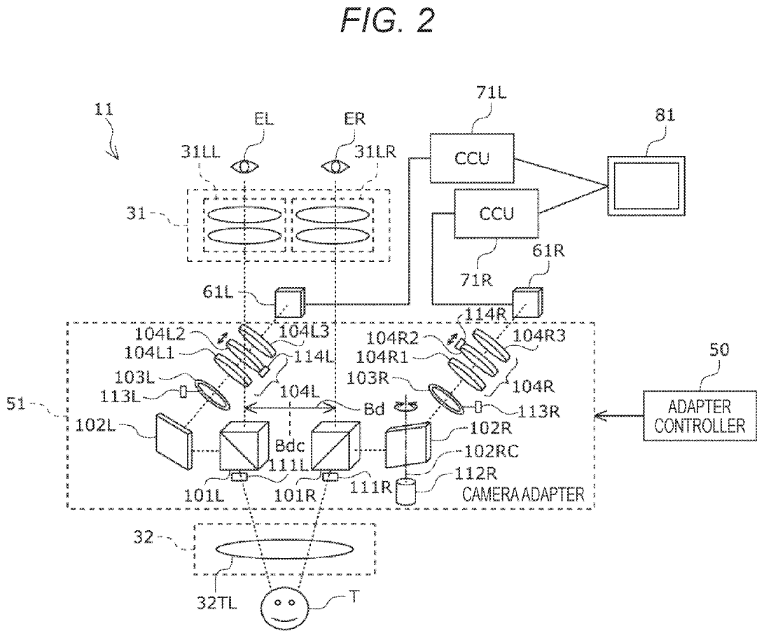

The microscope 21 includes an upper lens barrel 31 including eye lenses (31LL, 31LR (FIG. 2)) and a lower lens barrel 32 including an objective lens 32TL (FIG. 2).

Normally, the microscope 21 is configured such that a connection part 31D of the upper lens barrel 31 and a connection part 32U of the lower lens barrel 32 are connected in a state where optical axes of a left-eye eyepiece 31L and right-eye eyepiece 31R of the upper lens barrel 31 and a corresponding left-eye transmission part 32L and right-eye transmission part 32R of the lower lens barrel 32 coincide with each other.

Therefore, by using the microscope 21, an observer (for example, the surgeon) can enlarge and visually recognize the operative field Zr by looking into the microscope 21 through the right-eye eyepiece 31R and left-eye eyepiece 31L with right and left eyes.

The microscope system 11 has a configuration in which the camera adapter 51 is sandwiched and detachably connected between the upper lens barrel 31 and lower lens barrel 32 of the microscope 21. That is, although not illustrated, when the connection part 31D of the upper lens barrel 31 and the connection part 32U of the lower lens barrel 32 are directly connected without the camera adapter 51 being sandwiched, the microscope 21 functions as a general microscope.

With such a configuration, the camera adapter 51 optically splits and extracts a portion of light from the operative field Zr visually recognized through the right-eye eyepiece 31R and the left-eye eyepiece 31L, and enables cameras 61L, 61R (imaging devices) to capture an image of the operative field Zr.

Then, the cameras 61L, 61R (imaging devices) capture images of the operative field Zr extracted via the camera adapter 51, and causes the captured images to be displayed on the monitor 81 via the CCUs 71L, 71R. Note that the cameras 61L, 61R may be configured as an integrated camera including two image sensors, and in this case, each of the image sensors may be associated with an “imaging device”.

More specifically, the camera adapter 51 is connected to the microscope 21 when a connection part 51U and the connection part 31D of the upper lens barrel 31 are connected, and a connection part 51D and the connection part 32U of the lower lens barrel 32 are connected in a state where an optical axis of the left-eye eyepiece 31L and left-eye transmission part 32L and an optical axis of a hole part 51L coincide with each other, and an optical axis of the right-eye eyepiece 31R and right-eye transmission part 32R and an optical axis of a hole part 51R coincide with each other,

Moreover, light that is from the operative field Zr visually recognized by a left eye is split through a camera connection part 51CL so as to be able to be imaged by an imaging surface 61Lf of a camera 61L, and light that is from the operative field Zr visually recognized by a right eye is split so as to be able to be imaged by an imaging surface 61Rf of a camera 61R via a camera connection part 51CR.

The camera connection part 51CL is connected so as to face a connection part 61CL of the camera 61L that captures a left-eye image, and the camera connection part 51CR is connected so as to face a connection part 61CR of the camera 61R that captures a right-eye image.

With such a configuration, images of an operative field visually recognized by the right and left eyes are captured in the cameras 61L, 61R, respectively.

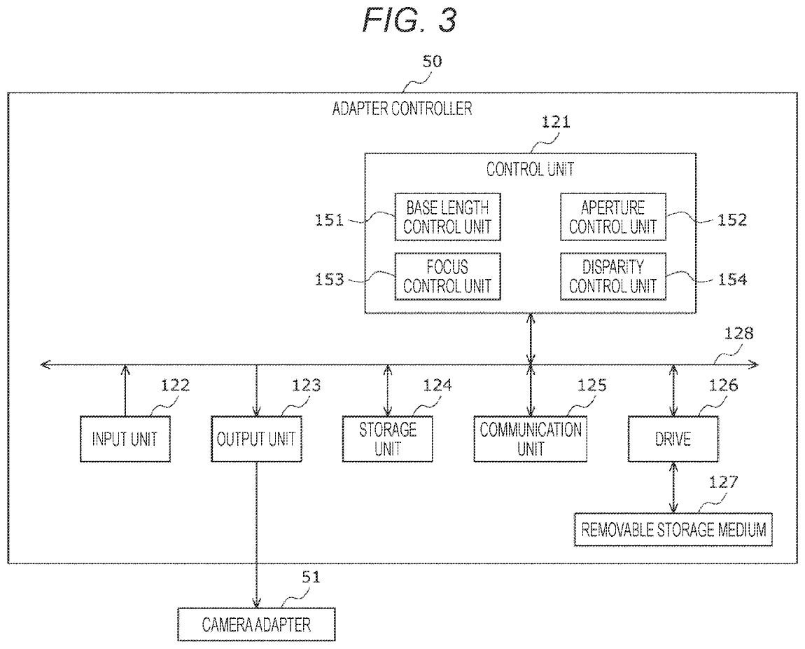

Furthermore, the adapter controller 50 is connected to the camera adapter 51, and at least one of a base length, which is a distance between the hole parts 51L, 51R in the camera adapter 51, aperture, focus, or disparity, for example, is adjusted by operating an input unit 122 (FIG. 3) provided on the adapter controller 50.

Note that detailed configurations of the camera adapter 51 and the adapter controller 50 will be described later in detail with reference to FIGS. 2 and 3.

The cameras 61L, 61R output the captured images to the CCUs 71L, 71R, respectively.

The CCUs 71L, 71R control aperture of the cameras 61L, 61R, a white level or black level of an image signal, a color tone, or the like, and display a control result, as a three-dimensional image, on the monitor 81 including a liquid crystal display (LCD) or organic electro luminescence (EL).

The monitor 81 may have any configuration as long as a three-dimensional image can be observed on the monitor 81, and may have, for example, a configuration using a parallax barrier, lenticular lens, or the like to achieve observation of a three-dimensional image with naked eyes, or may display each of the right-eye image and left-eye image as a specific polarized image to achieve observation of the three-dimensional image by using polarization glasses or the like.

<Configuration Example of Camera Adapter>

Next, a configuration example of the camera adapter 51 will be described with reference to FIG. 2.

The camera adapter 51 includes splitters 101L, 101R, mirrors 102L, 102R, diaphragm mechanism units 103L, 103R, and lenses 104L, 104R, and may further include base length adjustment units 111L, 111R, a mirror adjustment unit 112R, aperture adjustment units 113L, 113R, and lens adjustment units 114L, 114R.

Note that reference signs L and R are reference signs for distinguishing a configuration for a left eye and a configuration for a right eye, respectively, and basically other configurations denoted with the same reference signs are configurations having the same functions.

The splitters 101L, 101R transmit portions of light from a subject T, the light being incident through the objective lens 32TL that constitutes the lower lens barrel 32, toward a left eye EL and right eye ER of the surgeon through eye lenses 31LL, 31LR that constitute the upper lens barrel 31, and cause the light other than the portions of the light to split and be reflected toward the mirrors 102L, 102R.

The splitters 101L, 101R are configured to be able to change, by the base length adjustment units 111L, 111R, a base length Bd, which is a distance between the splitters 101L, 101R, the base length Bd being indicated by a linear arrow in the drawing.

More specifically, the splitters 101L, 101R are configured to be movable, by the base length adjustment units 111L, 111R, while maintaining an equidistance from a central position Bdc to both the splitters 101L, 101R, by which an interval of the base length Bd can be changed.

The base length Bd, which is the distance between the splitters 101L, 101R, corresponds to a center-to-center distance between the hole parts 51L, 51R in FIG. 1.

Therefore, because an interval between the hole parts 51L, 51R in FIG. 1 can be changed by changing the base length Bd, it is possible to correspond to microscopes 21 having various distances of an interval between the left-eye transmission part 32L and the right-eye transmission part 32R.

The mirrors 102L, 102R reflect light incident from the splitters 101L, 101R, respectively, in directions facing the imaging surfaces 61Lf, 61Rf of the cameras 61L, 61R, respectively.

Furthermore, the mirror 102R is configured to be rotatable, by the mirror adjustment unit 112R including a motor or the like, around an axis 102RC indicated by an alternate long and short dash line, and configured to be able to change a direction in which light from the splitter 101R reflects.

Thus, by causing the mirror adjustment unit 112R to rotate the mirror 102R around the axis 102RC, the direction in which the light from the splitter 101R reflects can be changed and adjusted on the imaging surface of the camera 61R with respect to a horizontal direction in the drawing.

By such adjustment of a reflection direction of the mirror 102R, it is possible to change disparity between the image captured by the camera 61R and the image captured by the camera 61L according to the reflection direction corresponding to an angle of the mirror 102R, and therefore, it is possible to adjust a sense of depth of the subject in the observation of the three-dimensional image (disparity can be adjusted).

The diaphragm mechanism units 103L, 103R are configured to be able to change an aperture area, for example, by being adjusted by the aperture adjustment units 113L, 113R, and adjust aperture by adjusting amount of light incident on the cameras 61L, 61R, respectively.

Both the lenses 104L, 104R are focus lenses, and adjust focus of images captured with the light incident on the cameras 61L, 61R, respectively.

More specifically, in the present embodiment, the lens 104L includes a lens group of lenses 104L1, 104L2, 104L3, which are arranged in that order from a side close to the diaphragm mechanism unit 103L, and the lens 104R includes a lens group of lenses 104R1, 104R2, 104R3, which are arranged in that order from a side close to the diaphragm mechanism unit 103R.

In other words, of the respective lens groups that constitute the lenses 104L, 104R, the lenses 104L1, 104R1 are lenses provided closest to sides of the objective lens 32TL, and, of the respective lens groups that constitute the lenses 104L, 104R, the lenses 104L3, 104R3 are lenses provided closest to sides of the cameras 61L, 61R.

Moreover, the lens adjustment units 114L, 114R can change positions of the lenses 104L2, 104R2 with respect to optical axis directions of light from the splitters 101L, 101R, the light being reflected on the mirrors 102L, 102R, and focus is adjusted by adjusting the positions of the lenses 104L2, 104R2.

<Configuration Example of Adapter Controller>

Next, a configuration example of the adapter controller 50 will be described with reference to the block diagram in FIG. 3.

The adapter controller 50 includes a remote controller, a general-purpose personal computer, or the like for example, but the adapter controller 50 may be built in the camera adapter 51 by a microcomputer. Furthermore, either or both of the CCUs 71L, 71R may have a function of the adapter controller 50.

The adapter controller 50 in FIG. 3 includes a control unit 121, the input unit 122, an output unit 123, a storage unit 124, a communication unit 125, a drive 126, and a removable storage medium 127 that are connected to one another via a bus 128, and can transmit and receive data or a program.

The control unit 121 includes a processor or a memory, and controls entire operation of the adapter controller 50.

Furthermore, the control unit 121 includes a base length control unit 151, an aperture control unit 152, a focus control unit 153, and a disparity control unit 154.

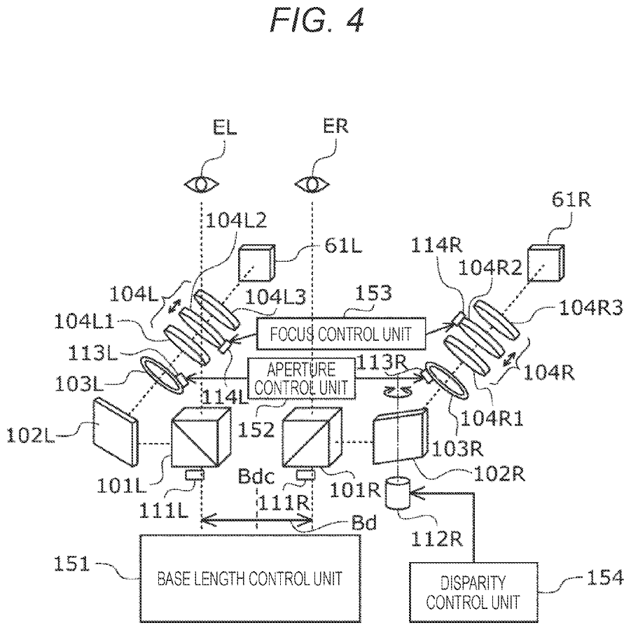

When the surgeon operates the input unit 122 to adjust the base line length Bd, according to a base length setting value for setting an input base length Bd, the base length control unit 151 simultaneously moves the base length adjustment units 111L, 111R by an equidistance, while maintaining positions of the base length adjustment units 111L, 111R equidistant from the central position Bdc as illustrated in FIG. 4, thereby adjusting the base length Bd, which is the distance between the splitters 101L, 101R.

When the surgeon operates the input unit 122 to adjust aperture, according to an aperture setting value for setting input aperture, as illustrated in FIG. 4, the aperture control unit 152 controls the aperture adjustment units 113L, 113R to simultaneously perform adjustment so that aperture areas of the diaphragm mechanism units 103L, 103R are in the same state, thereby adjusting aperture of the cameras 61L, 61R.

When the surgeon operates the input unit 122 to adjust focus, according to a focus setting value for setting input focus, the focus control unit 153 controls the lens adjustment units 114L, 114R to adjust focus of the lenses 104L, 104R as illustrated in FIG. 4.

More specifically, on the basis of the focus setting value, the lens adjustment units 114L, 114R cause the lenses 104L2, 104R2 of the lens groups, which constitute the lenses 104L, 104R respectively, to simultaneously move back and forth with respect to the optical axes by an equidistance in a direction of an arrow in the drawing, thereby adjusting focus.

When the surgeon operates the input unit 122 to adjust disparity, according to a disparity setting value for setting an input disparity, the disparity control unit 154 controls the mirror adjustment unit 112R to rotate the mirror 102R as indicated by an arrow to change the reflection direction of the mirror 102R as illustrated in FIG. 4, thereby adjusting disparity of an image captured in the cameras 61L, 61R.

The input unit 122 includes an operation device, such as a keyboard, a button, an operation knob, or an operation lever, for inputting an operation command or various setting values, and supplies the control unit 121 with an operation command corresponding to operation content, or a signal corresponding to various setting values.

Setting values set by the input unit 122 include a base length setting value for adjusting a base length, an aperture setting value for adjusting aperture, a focus setting value for adjusting focus, and a disparity setting value for adjusting disparity.

Therefore, in the input unit 122, individual operation devices capable of inputting a setting value necessary for each adjustment may be provided, or a plurality of setting values may be able to be set in the same operation device by switching an operation mode according to a type of a setting value.

The output unit 123 includes an image display unit including a liquid crystal display (LCD), organic electro luminescence (EL), or the like, and a light emission unit including a light emitting diode (LED) or the like, and is controlled by the control unit 121 to display various processing results, or the like.

In a case where the operation mode can be switched according to a type of a setting value, the type of the setting value that can be input by operating an operation device of the input unit 122 may be able to be displayed by the output unit 123.

The storage unit 124 includes a hard disk drive (HDD), a solid state drive (SSD), a semiconductor memory, or the like, and is controlled by the control unit 121 to write or read various data and programs.

Furthermore, the storage unit 124 may store various setting values input from the input unit 122 and set, and may read the setting values as appropriate.

The communication unit 125 is controlled by the control unit 121 to transmit and receive various data or programs to and from various devices by wire or wirelessly via a communication network represented by a local area network (LAN) or the like.

Furthermore, for various setting values input from the input unit 122, a setting value input by an external device being operated via the communication unit 125 may be used instead of a setting value corresponding to operation of the input unit 122.

The drive 126 reads and writes data from and to a removable storage medium 127 such as a magnetic disk (including a flexible disk), an optical disc (including a compact disc-read only memory (CD-ROM) and a digital versatile disc (DVD)), a magneto-optical disk (including a mini disc (MD)), or a semiconductor memory.

Furthermore, various setting values input from the input unit 122 and set may be stored in the removable storage medium 127 and be read as appropriate.

<Base Length Adjustment>

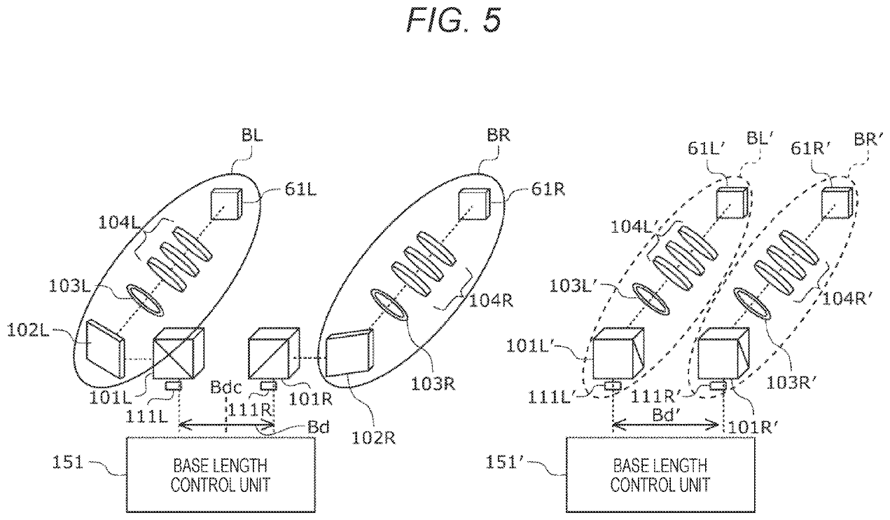

Next, base length adjustment by the base length control unit 151 will be described with reference to FIG. 5.

In the camera adapter 51 according to the present disclosure, as illustrated in the left part of FIG. 5, mirrors 102L, 102R are provided between the splitters 101L, 101R and the diaphragm mechanism units 103L, 103R, respectively.

With such a configuration, the base length control unit 151 controls the base length adjustment units 111L, 111R to simultaneously move the splitters 101L, 101R, while maintaining an equidistance from the central position Bdc to the splitters 101L, 101R to obtain a base length Bd between the splitters 101L, 101R based on the base length setting value set by the input unit 122 being operated, thereby adjusting the base length Bd.

The base line length, which is the distance between the splitters 101L, 101R, is adjusted by the base length adjustment units 111L, 111R being controlled by the base length control unit 151 on the basis of a setting value set by the input unit 122 being operated, and the splitters 101L, 101R are simultaneously moved so that the respective splitters 101L, 101R are equidistant from the central position Bdc of the base length.

With this arrangement, for example, it is possible to support microscopes 21 of different types with varied interval between the left-eye transmission part 32L and the right-eye transmission part 32R in the lower lens barrel 32 described with reference to FIG. 1.

Furthermore, at this time, in a state where, as in the left part of FIG. 5, a block BL including the mirror 102L to the camera 61L and surrounded by a circle, and a block BR including the mirror 102R to the camera 61R and surrounded by a circle are fixed, the base length control unit 151 is only required to control the base length adjustment units 111L, 111R to move only the splitters 101L, 101R on the base length Bd with reference to the central position Bdc, by which a structure can be simplified.

That is, for example, as illustrated in the right part of FIG. 5, in a case where the mirrors 102L, 102R are not provided, and the configuration includes splitters 101L′, 101R′, diaphragm mechanism units 103L′, 103R′, lenses 104L′, 104 R′, and cameras 61L′, 61R′, in order to move the splitters 101L′, 101R′, base length adjustment units 111L′, 111R′ need to move all of a block BL′ including a mirror 102L′ to the camera 61L′ and indicated by a dotted line and a block BR′ including a mirror 102R′ to the camera 61R′ and indicated by a dotted line along with movement of the splitters 101L′, 101R′, which requires a large-scale structure. Furthermore, in a case where the two splitters 101L′, 101R′ are moved, it is also necessary to move an interval between the two eye lenses 31LL, 31LR (eyepieces 31L, 31R) through which light to be observed by the observer (surgeon) with naked eyes passes, which is not suitable for observation.

With the above configuration, only by the input unit 122 being operated to input a base length setting value for setting the base length Bd, causing the base length control unit 151 to control the base length adjustment units 111L, 111R, the base length Bd between the splitters 101L, 101R can be adjusted.

With this arrangement, by using one base length setting value, without adjusting the positions of the splitters 101L, 101R individually to adjust the base length Bd, it is possible to adjust the base length Bd while simultaneously moving both the splitters 101L, 101R to positions equidistant from the central position Bdc on the base length Bd.

As a result, base length adjustment can be facilitated, by which it is possible to reduce burden of the base length adjustment on the surgeon and shorten surgery time, and to reduce burden of surgery on the patient.

<Aperture Adjustment>

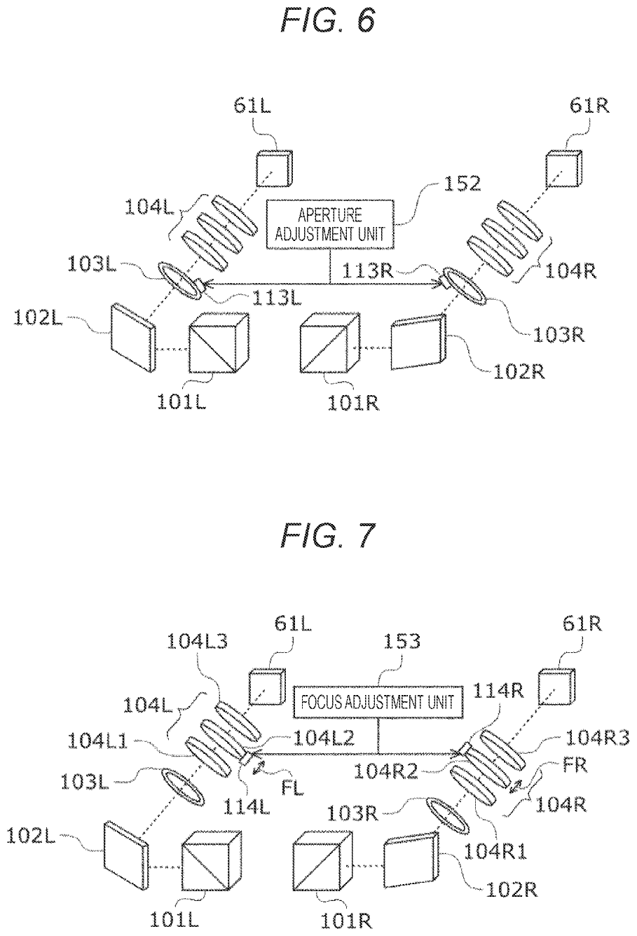

Next, aperture adjustment by the aperture control unit 152 will be described with reference to FIG. 6.

On the basis of an aperture setting value input from the input unit 122 for setting aperture, the aperture control unit 152 controls the aperture adjustment units 113L, 113R to simultaneously adjust amount of light, which is transmitted with aperture, that is, aperture areas, of the diaphragm mechanism units 103L, 103R, with respect to the diaphragm mechanism units 103L, 103R, while maintaining the same state.

With this arrangement, it is possible to simultaneously adjust the diaphragm mechanism units 103L, 103R to the same aperture by using one aperture setting value, without adjusting the diaphragm mechanism units 103L, 103R individually.

As a result, aperture adjustment can be facilitated, by which it is possible to reduce burden of the aperture adjustment on the surgeon and shorten surgery time, and to reduce burden of surgery on the patient.

<Focus Adjustment>

Next, focus adjustment of the lenses 104L, 104R by the focus control unit 153 will be described with reference to FIG. 7.

In the present embodiment, in a case where the lens 104L includes three lenses that are the lenses 104L1, 104L2, 104L3, which are arranged in that order from a side close to the diaphragm mechanism unit 103L (objective lens 32TL), and the lens 104R includes three lenses that are the lenses 104R1, 104R2, 104R3, which are arranged in that order from a side close to the diaphragm mechanism unit 103R (objective lens 32TL), the focus control unit 153 adjusts focus by controlling, on the basis of a focus setting value for adjusting focus input from the input unit 122, the lens adjustment units 114L, 114R to move the positions of the lenses 104L2, 104R2 toward directions of arrows FL, FR in the drawing, respectively.

Note that, adjustment can be performed by the lens adjustment units 114L, 114R moving, of the lens groups that constitute the respective lenses 104L, 104R, the lenses 104L1, 104R1 close to the diaphragm mechanism units 103L, 103R or the lenses 104L3, 104R3 close to the cameras 61L, 61R.

However, focus greatly changes with respect to a moving distance (sensitivity to the moving distance is great) in a case where lenses, such as the lenses 104L1, 104R1 or lenses 104L3, 104R3, which are at ends of the lens groups that constitute the lenses 104L, 104R, are moved, and therefore, adjustment is cumbersome in a case where it is necessary to adjust movement of a minute distance, or the like.

Furthermore, because there are individual errors (individual differences), such as minute distortion errors, between the lenses 104L1, 104R1 or between the lenses 104L3, 104R3, when focus greatly changes with respect to a moving distance of the lenses (sensitivity to the moving distance is great), adjustment in consideration of minute distortion errors different between the right and left is required, and there is a possibility that focus positions on the right and left need to be individually adjusted.

Meanwhile, the lenses 104L2, 104R2, which are center lenses of the three lens groups, have a small change in focus with respect to movement (sensitivity to the moving distance is small), and therefore, even if both the lenses 104L2, 104R2 are simultaneously moved by the same distance, the same focus adjustment can be performed easily. Furthermore, if positions of the lenses 104L1, 104R1 and lenses 104L3, 104R3 are accurately adjusted, it is possible to maintain a state where the right and left focus positions substantially coincide with each other, as long as the lenses 104L2, 104R2 are simultaneously moved by the same distance.

With this arrangement, it is possible to simultaneously adjust the lenses 104L2, 104R2 of the lenses 104L, 104R to the same focus position by using one focus setting value, without adjusting the lenses 104L2, 104R2 individually.

As a result, focus adjustment can be facilitated, by which it is possible to reduce burden of the focus adjustment on the surgeon and shorten surgery time, and to reduce burden of surgery on the patient.

Note that an example in which both the lenses 104L, 104R include three lenses each is described above, and in a case where there are three or more lenses included, similar adjustment is possible by causing at least one or more of lenses other than lenses closest to the diaphragm mechanism units 103L, 103R and lenses closest to the cameras 61L, 61R, in other words, lenses provided at a position between the lenses closest to the diaphragm mechanism units 103L, 103R and the lenses closest to the cameras 61L, 61R, to move back and forth along optical axes to adjust focus.

<Disparity Adjustment>

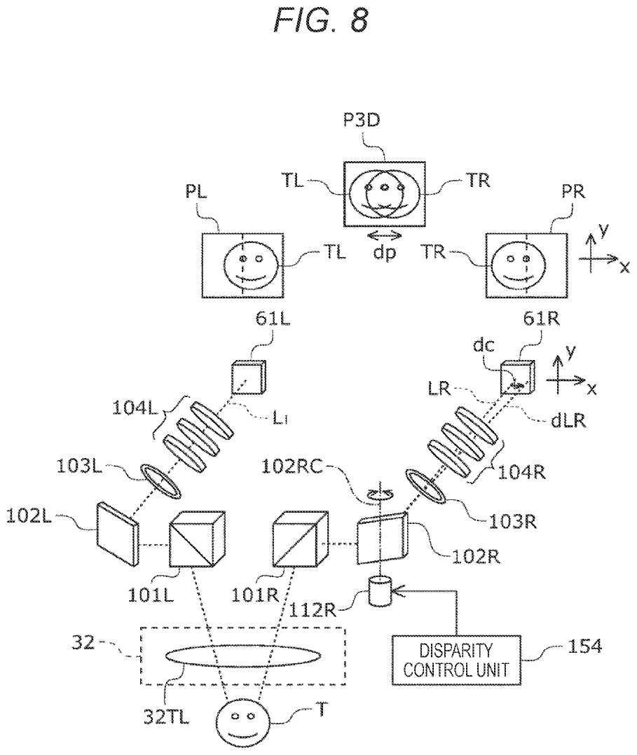

Next, disparity adjustment by the disparity control unit 154 will be described with reference to FIG. 8.

Because images captured by the cameras 61L, 61R are captured as images having disparity, the surgeon can recognize, with the right and left eyes, the images as a three-dimensional image by visually recognizing the images having the disparity.

That is, as illustrated in FIG. 8, in a case where an image of the subject T is captured through the objective lens 32TL in the lower lens barrel 32, an image TL in which the subject T is closer to right than a central position indicated by a dotted line is imaged on an image PL captured by the camera 61L.

Meanwhile, an image TR in which the subject T is closer to left than a central position indicated by a dotted line is imaged on an image PR captured by the camera 61R.

By visually recognizing the images PL, PR with the right and left eyes, the surgeon can recognize the subject T as a three-dimensional image P3D by disparity dp generated between the images TL, TR of the subject T.

The disparity control unit 154 controls the mirror adjustment unit 112R to rotate the mirror 102R around an axis 102RC indicated by an alternate long and short dash line to rotate a reflection direction of light from the splitter 101R in a direction of an arrow in the drawing, thereby moving an optical path LR indicated by a dotted line in FIG. 8 in the horizontal direction to change the optical path LR to, for example, an optical path dLR.

With this arrangement, on the imaging surface of the camera 61R, disparity between the images PL, PR changes by an imaging position moving by a distance dc.

With such a principle, on the basis of a disparity setting value set by the input unit 122, the disparity control unit 154 controls the mirror adjustment unit 112R to rotate the mirror 102R, thereby adjusting the disparity.

With this arrangement, the disparity can be adjusted with a disparity setting value for adjusting the mirror 102R.

As a result, disparity adjustment can be facilitated, by which it is possible to reduce burden of the disparity adjustment on the surgeon and shorten surgery time, and to reduce burden of surgery on the patient.

Note that, although an example in which the mirror 102R is caused to rotate has been described with reference to FIG. 8, a similar configuration may be provided in the mirror 102L, and disparity may be adjusted by the mirror 102L, or both the mirrors 102L, 102R may be able to rotate to adjust disparity.

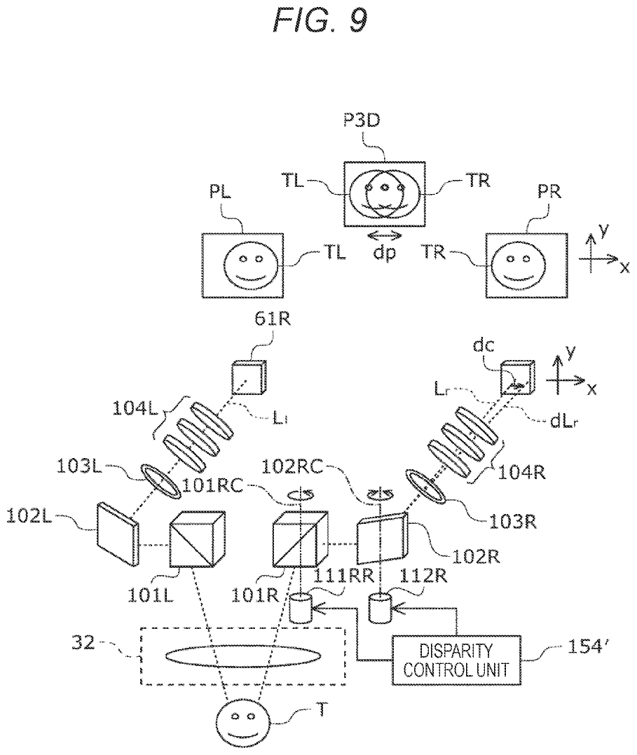

Furthermore, although an example in which only the mirror 102R (and/or 102L) is rotated to adjust disparity has been described in FIG. 8, as illustrated in FIG. 9, a splitter direction adjustment unit 111RR may also be provided so that, on the basis of a disparity adjustment value, the splitter 101R can be rotated around a rotation axis 101RC to change an optical path, thereby adjusting disparity.

Moreover, also in the example in FIG. 9, the disparity may be adjusted by causing the splitter 101L to rotate similarly, or the disparity may be adjusted by having both of the splitters 101L, 101R rotatable.

Furthermore, although the disparity can be adjusted with signal processing by the CCUs 71L, 71R, in which a delay may occur due to the signal processing, the delay due to the signal processing can also be reduced by rotating the mirror 102R, the splitter 101R, or the like to optically adjust the disparity.

### 2. Modifications

Although an example of the camera adapter 51 configured such that the imaging surfaces of the cameras 61L, 61R are parallel to each other has been described above, for example, the imaging surfaces of the cameras 61L, 61R may face each other.

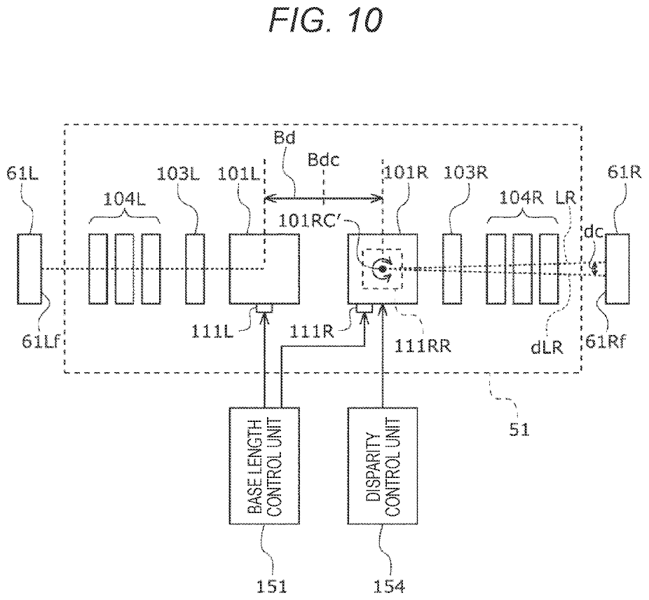

FIG. 10 illustrates a configuration example of the camera adapter 51 in a case where the imaging surfaces of the cameras 61L, 61R face each other.

Note that FIG. 10 illustrates a configuration of the camera adapter 51 when viewed from a side surface direction of the microscope system 11 in FIG. 1 and a direction perpendicular to a straight line forming a base length that is a distance between the splitters 101L, 101R.

In FIG. 10, a portion of light incident through the objective lens 32TL of the lower lens barrel 32 from a lower direction in the drawing is split in left and right directions in the drawing by the splitters 101L, 101R, and is incident on the imaging surfaces 61Lf, 61Rf of the cameras 61L, 61R through the diaphragm mechanism units 103L, 103R and the lenses 104L, 104R, respectively.

That is, light other than the portion of the light incident through the objective lens 32TL of the lower lens barrel 32 from the lower direction in the drawing is visually recognized through the eye lenses 31LL, 31LR in an upper part of the drawing by the left eye EL and right eye ER of the surgeon.

With this arrangement, the mirrors 102L, 120R are unnecessary, and therefore, the configuration can be simplified.

Furthermore, even in a case of FIG. 10, the base length Bd can be adjusted simultaneously such that the splitters 101L, 101R are equidistant from the central position Bdc therebetween, by the base length control unit 151 controlling, on the basis of a base length setting value, the base length adjustment units 111L, 111R to move the splitters 101L, 101R only.

Moreover, even in the case of FIG. 10, it is possible to change disparity only by the distance dc, by the disparity control unit 154 controlling, on the basis of a disparity setting value, the splitter direction adjustment unit 111RR in a direction of an arrow in the drawing to rotate around an axis 101RC′ of the splitter 101R to change the optical path LR to, for example, the optical path dLR.

Note that adjustment of the diaphragm mechanism units 103L, 103R and lenses 104L, 104R is similar to the adjustment described above, and thus the description thereof will be omitted.

With the above configuration, in the microscope system according to the present disclosure, adjustment of a base length, aperture, focus, and disparity can be performed by operating the input unit 122 only once to set one setting value necessary for each adjustment.

As a result, it is possible to facilitate adjustment of a base length, aperture, focus, and disparity, and therefore, it is possible to reduce burden of adjustment of a base length, aperture, focus, or disparity on a surgeon and shorten surgery time, and to reduce burden of surgery on the patient.

Note that the present disclosure can have the following configurations.

<1> A surgical microscope system including

an optical adjustment unit that is provided between an objective lens and eye lenses in a surgical microscope, and adjusts an optical system so that two imaging devices are able to capture images of an operative field as a right-eye image and a left-eye image,

a control unit that performs control so as to simultaneously adjust, in the optical adjustment unit, an optical system used for capturing the right-eye image and the left-eye image by the two imaging devices,

an imaging control unit that controls each of the imaging devices to output an image signal generated by the imaging devices, and

a display unit that displays an image based on the image signal output from the imaging control unit.

<2> The surgical microscope system according to <1>,

in which the optical adjustment unit further includes,
as a configuration that adjusts the optical system, two focus-lens adjustment units that adjust focus of two focus lenses used for capturing the right-eye image and the left-eye image, and

the control unit further includes
a focus control unit that adjusts the focus of the two focus lenses by simultaneously controlling the two focus-lens adjustment units.

<3> The surgical microscope system according to <2>,

in which the two focus lenses include a lens group including a lens of a first group closest to a side of the objective lens to a plurality of lenses of an n-th (n 3) group closest to a side of the respective imaging devices, and

the focus control unit adjusts focus of the two focus lenses by controlling the two focus-lens adjustment units to simultaneously move the lenses of a second group to an (n−1)-th group of the lens groups that constitute the two focus lenses by the same distance with respect to an optical axis of incident light.

<4> The surgical microscope system according to <2>, further including an operation unit that receives input of a focus setting value that is a setting value for adjusting focus of the two focus lenses,

in which the focus control unit adjusts the focus by controlling, on the basis of the focus setting value, the two focus-lens adjustment units to simultaneously control the two focus lenses.

<5> The surgical microscope system according to any one of <1> to <4>,

in which the optical adjustment unit further includes,
as a configuration that adjusts the optical system, two aperture adjustment units that adjust each aperture of the two imaging devices that capture the right-eye image and the left-eye image with two diaphragm mechanism units, and

the control unit further includes
an aperture control unit that adjusts each aperture of the two imaging devices by controlling the two aperture adjustment units to simultaneously adjust the two diaphragm mechanism units in the same state.

<6> The surgical microscope system according to <5>, further including an operation unit that receives input of an aperture setting value that is a setting value for adjusting the aperture,

in which the aperture control unit adjusts aperture of the two imaging devices by controlling, on the basis of the aperture setting value, the two aperture adjustment units to simultaneously adjust the two diaphragm mechanism units in the same state.

<7> The surgical microscope system according to any one of <1> to <6>,

in which the optical adjustment unit further includes,
as a configuration that adjusts the optical system, two splitters that split a portion of incident light formed as the right-eye image and as the left-eye image to respective eye lenses and split the incident light other than the portion of the incident light to the respective imaging devices, and
two base length adjustment units that cause the two splitters to move so as to change a base length that is a distance between the two splitters, and

the control unit further includes
a base length control unit that adjusts the base length by controlling the two base length adjustment units to maintain a state where the two splitters are equidistant from a central position of the two splitters and simultaneously change a base length that is a distance between the two splitters.

<8> The surgical microscope system according to <7>, further including an operation unit that receives input of a base length setting value that is a setting value for adjusting the base length,

in which the base length control unit adjusts the base length by controlling, on the basis of the base length setting value, the two base length adjustment units to maintain a state where the two splitters are equidistant from a central position of the two splitters and simultaneously change a base length that is a distance between the two splitters.

<9> The surgical microscope system according to <7>,

in which the optical adjustment unit includes,
as a configuration that adjusts the optical system, two mirrors that reflect, on the respective imaging devices, incident light formed as the right-eye image and as the left-eye image, the incident light being split to the imaging devices by
the two respective splitters, and a mirror adjustment unit that changes a reflection direction of at least either one of the two mirrors.

<10> The surgical microscope system according to <9>,

in which the control unit further includes
a disparity control unit that adjusts disparity between the right-eye image and the left-eye image by controlling the mirror adjustment unit of at least either one of the two mirrors to adjust a reflection direction.

<11> The surgical microscope system according to <10>,

in which at least either one of the two splitters further includes a splitter direction adjustment unit that changes a split direction of incident light formed as the right-eye image and the left-eye image split to the imaging devices, and

disparity between the right-eye image and the left-eye image is adjusted by at least either control, of control of a reflection direction of at least either one of the two mirrors by the mirror adjustment unit controlled by the disparity control unit, or control, by the splitter direction adjustment unit controlled by the disparity control unit, of a split direction of at least either incident light formed as the right-eye image or the left-eye image, the incident light being split by the splitters.

<12> The surgical microscope system according to <10>, further including an operation unit that receives input of a disparity setting value that is a setting value for adjusting the disparity,

in which the disparity control unit adjusts disparity between the right-eye image and the left-eye image by controlling, on the basis of the disparity setting value, the mirror adjustment unit to adjust a reflection direction of at least either one of the two mirrors.

<13> A microscope camera adapter including

an optical adjustment unit that is provided between an objective lens and eye lenses in a surgical microscope, and adjusts an optical system so that two imaging devices are able to capture images of an operative field as a right-eye image and a left-eye image, and

an adjustment unit that simultaneously adjusts, in the optical adjustment unit, an optical system used for capturing the right-eye image and the left-eye image by the two imaging devices.

<14> The microscope camera adapter according to <13>,

in which the optical adjustment unit further includes,
as a configuration that adjusts the optical system, two focus lenses that adjust focus of the respective right-eye image and left-eye image, and

the adjustment unit further includes
two focus-lens adjustment units that adjust the focus of the two focus lenses by simultaneously moving the two focus lenses.

<15> The microscope camera adapter according to <14>,

in which the two focus lenses include a lens group including a lens of a first group closest to a side of the objective lens to lenses of an n-th (n 3) group closest to a side of the respective imaging devices, and

the focus-lens adjustment unit adjusts focus by causing lenses of a second group to an (n−1)-th group of the lens groups that constitute the two focus lenses to simultaneously move by the same distance with respect to an optical axis of incident light.

<16> The microscope camera adapter according to <13> or <14>,

in which the optical adjustment unit further includes,
as a configuration that adjusts the optical system, two diaphragm mechanism units that adjust aperture of each of the two imaging devices that capture the right-eye image and the left-eye image, and

the adjustment unit further includes
two aperture adjustment units that adjust aperture of the two imaging devices by simultaneously adjusting the two diaphragm mechanism units at the same aperture.

<17> The microscope camera adapter according to any one of <13> to <16>,

in which the optical adjustment unit further includes,
as a configuration that adjusts the optical system, two splitters that split a portion of incident light formed as the right-eye image and as the left-eye image to respective eye lenses and split the incident light other than the portion of the incident light to the respective imaging devices, and

the adjustment unit further includes
two base length adjustment units that adjust a base length that is a distance between the two splitters by maintaining a state where the two splitters are equidistant from a central position of the two splitters and simultaneously move the two splitters.

<18> The microscope camera adapter according to <13>,

in which the optical adjustment unit further includes,
as a configuration that adjusts the optical system, two mirrors that reflect, on the respective imaging devices, incident light formed as the right-eye image and as the left-eye image, the incident light being split to the imaging devices by the two respective splitters.

<19> The microscope camera adapter according to <18>,

in which the adjustment unit further includes
a mirror adjustment unit that adjusts disparity between the right-eye image and the left-eye image by controlling a reflection direction of at least either one of the two mirrors.

<20> The microscope camera adapter according to <19>, further including a splitter direction adjustment unit that changes a split direction of incident light formed as the right-eye image and the left-eye image split, in which at least either one of the two splitters is split to the respective imaging devices,

in which disparity between the right-eye image and the left-eye image is adjusted by at least either control, of control of a reflection direction of at least either one of the two mirrors by the mirror adjustment unit, or control, by the splitter direction adjustment unit, of a split direction of at least either incident light formed as the right-eye image or the left-eye image, the incident light being split by the splitters.

### REFERENCE SIGNS LIST

11 Microscope system
21 Microscope
31 Upper lens barrel
32 Lower lens barrel
50 Adapter controller
51 Camera adapter
61L, 61R Camera
71L, 71R CCU
81 Monitor
101L, 101R Splitter
102L, 102R Mirror
103L, 103R Diaphragm
104 L, 104 R, 104 L1 to 104 L3, 104 R1 to 104 R3 Lens
111L, 111R Base length adjustment unit
111RR Splitter direction adjustment unit
112L, 112R Mirror adjustment unit
113L, 113R Aperture adjustment unit
114L, 114R Lens adjustment unit
121 Control unit
122 Input unit
123 Output unit
151 Base length control unit
152 Aperture control unit
153 Focus control unit
154 Disparity control unit

1. A surgical microscope system comprising:
an optical adjustment unit that is provided between an objective lens and eye lenses in a surgical microscope, and adjusts an optical system so that two imaging devices are able to capture images of an operative field as a right-eye image and a left-eye image;
a control unit that performs control so as to simultaneously adjust, in the optical adjustment unit, an optical system used for capturing the right-eye image and the left-eye image by the two imaging devices;
an imaging control unit that controls each of the imaging devices to output an image signal generated by the imaging devices; and
a display unit that displays an image based on the image signal output from the imaging control unit.

2. The surgical microscope system according to claim 1,
wherein the optical adjustment unit further includes,
as a configuration that adjusts the optical system, two focus-lens adjustment units that adjust focus of two focus lenses used for capturing the right-eye image and the left-eye image, and
the control unit further includes
a focus control unit that adjusts the focus of the two focus lenses by simultaneously controlling the two focus-lens adjustment units.

3. The surgical microscope system according to claim 2,
wherein the two focus lenses include a lens group including a lens of a first group closest to a side of the objective lens to a plurality of lenses of an n-th (n≥3) group closest to a side of the respective imaging device, and
the focus control unit adjusts focus of the two focus lenses by controlling the two focus-lens adjustment units to simultaneously move the lenses of a second group to an (n−1)-th group of the lens groups that constitute the two focus lenses by a same distance with respect to an optical axis of incident light.

4. The surgical microscope system according to claim 2, further comprising an operation unit that receives input of a focus setting value that is a setting value for adjusting focus of the two focus lenses,
wherein the focus control unit adjusts the focus by controlling, on a basis of the focus setting value, the two focus-lens adjustment units to simultaneously control the two focus lenses.

5. The surgical microscope system according to claim 1,
wherein the optical adjustment unit further includes,
as a configuration that adjusts the optical system, two aperture adjustment units that adjust each aperture of the two imaging devices that capture the right-eye image and the left-eye image with two diaphragm mechanism units, and
the control unit further includes
an aperture control unit that adjusts each aperture of the two imaging devices by controlling the two aperture adjustment units to simultaneously adjust the two diaphragm mechanism units in a same state.

6. The surgical microscope system according to claim 5, further comprising an operation unit that receives input of an aperture setting value that is a setting value for adjusting the aperture,
wherein the aperture control unit adjusts aperture of the two imaging devices by controlling, on a basis of the aperture setting value, the two aperture adjustment units to simultaneously adjust the two diaphragm mechanism units in a same state.

7. The surgical microscope system according to claim 1,
wherein the optical adjustment unit further includes,
as a configuration that adjusts the optical system, two splitters that split a portion of incident light formed as the right-eye image and as the left-eye image to respective eye lenses and split the incident light other than the portion of the incident light to the respective imaging devices, and
two base length adjustment units that cause the two splitters to move so as to change a base length that is a distance between the two splitters, and
the control unit further includes
a base length control unit that adjusts the base length by controlling the two base length adjustment units to maintain a state where the two splitters are equidistant from a central position of the two splitters and simultaneously change a base length that is a distance between the two splitters.

8. The surgical microscope system according to claim 7, further comprising an operation unit that receives input of a base length setting value that is a setting value for adjusting the base length,
wherein the base length control unit adjusts the base length by controlling, on a basis of the base length setting value, the two base length adjustment units to maintain a state where the two splitters are equidistant from a central position of the two splitters and simultaneously change a base length that is a distance between the two splitters.

9. The surgical microscope system according to claim 7,
wherein the optical adjustment unit includes:
as a configuration that adjusts the optical system, two mirrors that reflect, on the respective imaging devices, incident light formed as the right-eye image and as the left-eye image, the incident light being split to the imaging devices by the two respective splitters; and
a mirror adjustment unit that changes a reflection direction of at least either one of the two mirrors.

10. The surgical microscope system according to claim 9,
wherein the control unit further includes
a disparity control unit that adjusts disparity between the right-eye image and the left-eye image by controlling the mirror adjustment unit of at least either one of the two mirrors to adjust a reflection direction.

11. The surgical microscope system according to claim 10,
wherein at least either one of the two splitters further includes a splitter direction adjustment unit that changes a split direction of incident light formed as the right-eye image and the left-eye image split to the imaging devices, and
disparity between the right-eye image and the left-eye image is adjusted by at least either control, of control of a reflection direction of at least either one of the two mirrors by the mirror adjustment unit controlled by the disparity control unit, or control, by the splitter direction adjustment unit controlled by the disparity control unit, of a split direction of at least either incident light formed as the right-eye image or the left-eye image, the incident light being split by the splitters.

12. The surgical microscope system according to claim 10, further comprising an operation unit that receives input of a disparity setting value that is a setting value for adjusting the disparity,
wherein the disparity control unit adjusts disparity between the right-eye image and the left-eye image by controlling, on a basis of the disparity setting value, the mirror adjustment unit to adjust a reflection direction of at least either one of the two mirrors.

13. A microscope camera adapter comprising:
an optical adjustment unit that is provided between an objective lens and eye lenses in a surgical microscope, and adjusts an optical system so that two imaging devices are able to capture images of an operative field as a right-eye image and a left-eye image; and
an adjustment unit that simultaneously adjusts, in the optical adjustment unit, an optical system used for capturing the right-eye image and the left-eye image by the two imaging devices.

14. The microscope camera adapter according to claim 13,
wherein the optical adjustment unit further includes,
as a configuration that adjusts the optical system, two focus lenses that adjust focus of the respective right-eye image and left-eye image, and
the adjustment unit further includes
two focus-lens adjustment units that adjust the focus of the two focus lenses by simultaneously moving the two focus lenses.

15. The microscope camera adapter according to claim 14,
wherein the two focus lenses include a lens group including a lens of a first group closest to a side of the objective lens to lenses of an n-th (n≥3) group closest to a side of the respective imaging devices, and
the focus-lens adjustment unit adjusts focus by causing lenses of a second group to an (n−1)-th group of the lens groups that constitute the two focus lenses to simultaneously move by a same distance with respect to an optical axis of incident light.

16. The microscope camera adapter according to claim 13,
wherein the optical adjustment unit further includes,
as a configuration that adjusts the optical system, two diaphragm mechanism units that adjust aperture of each of the two imaging devices that capture the right-eye image and the left-eye image, and
the adjustment unit further includes
two aperture adjustment units that adjust aperture of the two imaging devices by simultaneously adjusting the two diaphragm mechanism units at a same aperture.

17. The microscope camera adapter according to claim 13,
wherein the optical adjustment unit further includes,
as a configuration that adjusts the optical system, two splitters that split a portion of incident light formed as the right-eye image and as the left-eye image to respective eye lenses and split the incident light other than the portion of the incident light to the respective imaging devices, and
the adjustment unit further includes
two base length adjustment units that adjust a base length that is a distance between the two splitters by maintaining a state where the two splitters are equidistant from a central position of the two splitters and simultaneously move the two splitters.

18. The microscope camera adapter according to claim 13,
wherein the optical adjustment unit further includes,
as a configuration that adjusts the optical system, two mirrors that reflect, on the respective imaging devices, incident light formed as the right-eye image and as the left-eye image, the incident light being split to the imaging devices by the two respective splitters.

19. The microscope camera adapter according to claim 18,
wherein the adjustment unit further includes
a mirror adjustment unit that adjusts disparity between the right-eye image and the left-eye image by controlling a reflection direction of at least either one of the two mirrors.

20. The microscope camera adapter according to claim 19, further comprising a splitter direction adjustment unit that changes a split direction of incident light formed as the right-eye image and the left-eye image split, in which at least either one of the two splitters is split to the respective imaging devices,
wherein disparity between the right-eye image and the left-eye image is adjusted by at least either control, of control of a reflection direction of at least either one of the two mirrors by the mirror adjustment unit, or control, by the splitter direction adjustment unit, of a split direction of at least either incident light formed as the right-eye image or the left-eye image, the incident light being split by the splitters.
